(19) United States
(12) Patent Application Publication
(10) Pub. No.: US 2012/0214889 A1
(43) Pub. Date: Aug. 23, 2012

(54) METHOD FOR THE PRODUCING ANHYDRIDE-CONTAINING VINYL AROMATIC-VINYL CYANIDE COPOLYMERS HAVING REDUCED DIRT PARTICLE CONTENT

(75) Inventors: Martin Weber, Maikammer (DE); Peter Ittemann, Lampertheim (DE); Axel Gottschalk, Neustadt (DE); Bernd Niedermaier, Ludwigshafen (DE); Birgit Reinhard, Limburgerhof (DE); Dirk Meckelnburg, Limburgerhof (DE)

(73) Assignee: BASF SE, Ludwigshafen (DE)

(21) Appl. No.: 13/504,576

(22) PCT Filed: Oct. 25, 2010
(86) PCT No.: PCT/EP2010/066012

§ 371 Date: Apr. 27, 2012

(30) Foreign Application Priority Data
Oct. 29, 2009 (EP) 09174501.8

(51) Int. Cl. C08L 37/00; C08J 9/00; C08F 222/08

(52) U.S. Cl. 521/139; 526/272; 524/517; 521/147

(57) ABSTRACT

The present invention relates to processes for preparing copolymers A) with a reduced soil particle content, comprising
49.2 to 93.2% by weight of structural units which derive from one or more vinylaromatic monomers (component A1)),
6 to 50% by weight of structural units which derive from one or more vinyl cyanides (component A2)),
0.8 to 7% by weight of structural units which derive from one or more dicarboxylic anhydrides (component A3)) and
0 to 25% by weight of structural units which derive from further copolymerizable monomers (component A4)),
   where the percentages by weight are each based on the total weight of the structural units which derive from components A1), A2), A3) and A4), and together add up to 100% by weight,
   by bulk or solution polymerization,
   it being essential to the invention that the mathematical product of the percentages by weight of the structural units which derive from component A2) and the percentages by weight of the structural units which derive from component A3) in the copolymer A) is in the range from 40%² by weight to 65%² by weight.

The present invention further relates to the copolymers A), to thermoplastic molding materials comprising the copolymers A), to the use of the copolymers A) and of the thermoplastic molding materials, and to the moldings, films, fibers and foams obtainable from the copolymers A) and the thermoplastic molding materials.

The present invention relates to processes for preparing copolymers A) with a reduced soil particle content, comprising
49.2 to 93.2% by weight of structural units which derive from one or more vinylaromatic monomers (component A1)),
6 to 50% by weight of structural units which derive from one or more vinyl cyanides (component A2)),
0.8 to 7% by weight of structural units which derive from one or more dicarboxylic anhydrides (component A3)) and
0 to 25% by weight of structural units which derive from further copolymerizable monomers (component A4)),
   where the percentages by weight are each based on the total weight of the structural units which derive from components A1), A2), A3) and A4), and together add up to 100% by weight,
   by bulk or solution polymerization.

The present invention further relates to the copolymers A), to thermoplastic molding materials comprising the copolymers A), to the use of the copolymers A) and of the thermoplastic molding materials, and to the moldings, films, fibers and foams obtainable from the copolymers A) and the thermoplastic molding materials.

Anhydride-containing vinylaromatic-vinyl cyanide copolymers as such, for example styrene-acrylonitrile-maleic anhydride copolymers, and processes for preparation thereof are known.

For example, DE 25 40 517 A1 discloses, inter alia, polymers based on styrene, acrylonitrile and maleic anhydride, which are prepared by a specific continuous bulk polymerization in a plurality of process stages in the presence of polymerization initiators. The specifically disclosed polymers of this kind have comparatively high proportions of structural units which derive from maleic anhydride; the mathematical product of the percentages by weight of the structural units which derive from acrylonitrile and the percentages by weight of the structural units which derive from maleic anhydride in the specifically disclosed polymers of this kind is always either less than 20%² by weight or greater than 130%² by weight.

EP 0 001 625 A1 provides, inter alia, specific terpolymers of styrene, acrylonitrile and maleic anhydride. The maleic anhydride content in these terpolymers is between 7.5 and 15% by weight. They are prepared by continuous bulk polymerization in the presence of an initiator which decomposes to free radicals.

U.S. Pat. No. 2,439,227 discloses styrene-acrylonitrile-maleic anhydride terpolymers which have improved mechanical strength and thermal stability. These terpolymers are prepared from monomer mixtures which each include 7.5 to 27.5% by weight of acrylonitrile and maleic anhydride.

DE 10 2005 055 080 A1 discloses processes for preparing copolymers from vinylaromatics, vinyl cyanides and dicarboxylic anhydrides, in which the presence of a particular amount of water during the polymerization can result, inter alia, in an improved intrinsic color of the copolymers. The mathematical products disclosed specifically in the examples of this document of the percentages by weight of the structural units which derive from acrylonitrile and the percentages by weight of the structural units which derive from maleic anhydride are always either less than 40%² by weight or greater than 65%² by weight.

In the case of copolymers of vinylaromatic monomers, vinyl cyanides and dicarboxylic anhydrides preparable by these known processes, however, with increasing operating time of the polymerization, not only a possible deterioration in the intrinsic color but also a rise in the soil particle content occurs. This firstly adversely affects the quality of the copolymers, and secondly necessitates an increased level of cleaning in the polymerization plant.

It was therefore an object of the present invention to provide copolymers based on vinylaromatic monomers, vinyl cyanides and dicarboxylic anhydrides, which have a comparatively good intrinsic color and a reduced soil particle content compared to known copolymers of this kind even after a prolonged operating time of the polymerization. Suitable preparation processes for such copolymers were likewise to be provided.

Accordingly, the processes defined at the outset for preparing the copolymers A) have been found, it being essential to the invention that the mathematical product of the percentages by weight of the structural units which derive from component A2) and the percentages by weight of the structural units which derive from component A3) in the copolymer A) is in the range from 40%² by weight to 65%² by weight.

Additionally found have been copolymers A) based on vinylaromatic monomers, vinyl cyanides and dicarboxylic anhydrides, thermoplastic molding materials comprising these copolymers A), the uses of these copolymers A) or of these thermoplastic molding materials, and moldings, films, fibers and foams comprising these copolymers A) or these thermoplastic molding materials.

The inventive processes, copolymers, thermoplastic molding materials, uses and moldings, films, fibers and foams are described hereinafter.

For preparation of the copolymers A) which are low in soil particles and comprise A1) one or more vinylaromatic monomers, A2) one or more vinyl cyanides and A3) one or more dicarboxylic anhydrides, all bulk or solution polymerization processes which are known to those skilled in the art and are described in the prior art, for example in DE 100 58 302 A1 and the documents cited there, are suitable in principle. It is essential to the invention that the copolymers A) prepared by these processes comprise:

49.2 to 93.2% by weight, preferably 58.5 to 88.5% by weight, more preferably 66.3 to 83.3% by weight, of structural units which derive from component A1),

6 to 50% by weight, preferably 10 to 40% by weight, more preferably 15 to 32% by weight, of structural units which derive from component A2),

0.8 to 7% by weight, preferably 1.5 to 5% by weight, more preferably 1.7 to 3.6% by weight, of structural units which derive from component A3) and

0 to 25% by weight, preferably 0 to 15% by weight, more preferably 0 to 10% by weight, of structural units which derive from component A4),

where the percentages by weight are each based on the total weight of the structural units which derive from components A1), A2), A3) and A4), and together add up to 100% by weight, and where
the mathematical product of the percentages by weight of the structural units which derive from component A2) and the percentages by weight of the structural units which derive from component A3) in the copolymer A) is in the range from 40%² by weight to 65%² by weight, preferably in the range from 50%² by weight to 60%² by weight, more preferably in the range from 54%² by weight to 58%² by weight.

Useful components A1) include all vinylaromatic monomers which are known to those skilled in the art and are described in the prior art, for example DE 100 58 302 A1; preference is given to using styrene, α-methylstyrene, p-methylstyrene, t-butylstyrene, vinylnaphthalene or mixtures thereof; particular preference is given to using styrene.

Useful components A2) include all vinyl cyanides which are known to those skilled in the art and are described in the prior art, for example DE 25 40 517 A1; preference is given to using acrylonitrile, methacrylonitrile or mixtures thereof; particular preference is given to using acrylonitrile.

Useful components A3) include all dicarboxylic anhydrides which are known to those skilled in the art and are described in the prior art; preference is given to using maleic anhydride, methylmaleic anhydride, itaconic anhydride or mixtures thereof; particular preference is given to using maleic anhydride.

The components A4) used in the inventive copolymers A) may be further monomers which are copolymerizable with components A1), A2) and A3) and are different therefrom.

The copolymers A) are more preferably styrene-acrylonitrile-maleic anhydride copolymers.

The copolymers A) are prepared by bulk or solution polymerization, but preferably as a solution polymerization in the presence of an organic solvent, for example cyclohexane, ethylbenzene, toluene or dimethyl sulfoxide, preferably ethylbenzene.

Both in the case of solution polymerization and in the case of bulk polymerization, the polymerization reaction can in principle be initiated by adding chemical polymerization initiators, as described, for example, in DE 100 58 302 A1; preference is given to effecting the initiation, however, purely thermally, i.e. without addition of a polymerization initiator.

The preparation can be effected in a batchwise or semibatchwise process, but preference is given to performing a continuous process regime.

In an especially preferred embodiment of the processes according to the invention, the process regime is continuous under steady-state conditions; “under steady-state conditions” means that the concentrations of all reaction participants and the composition of the copolymers A) formed remain virtually constant over the duration of the reaction (information regarding the connection between monomer composition and polymer composition and regarding the steady-state reaction regime can be taken especially from EP 0 001 625 A1 and DE 25 40 517 A1).

Suitable process parameters, such as pressure, temperature, residence times, etc., suitable apparatus for performing the processes and suitable rates of metered addition of the monomers, if present of the solvents, if present of the initiators and optionally of further polymerization additives, are known to those skilled in the art and are described in the prior art.

The workup of the polymerization mixture and the isolation of the copolymers A) can be effected by methods which are known to those skilled in the art and described in the prior art, for example by removing low molecular weight compounds by means of application of reduced pressure or stripping with inert gas.

The copolymers A) prepared by the processes according to the invention differ on the basis of the specific monomer composition thereof from known copolymers of this kind to the effect that they have a comparatively good intrinsic color and a reduced soil particle content even after prolonged operating time of the polymerization.

The inventive copolymers A) can be processed with one or more further thermoplastic polymers B), for example styrene-acrylonitrile copolymers (SAN) or alpha-methylstyrene-acrylonitrile copolymers (AMSAN), polyamide (PA), polyesters such as polybutylene terephthalate (PBT) or polyethylene terephthalate (PET), poly(meth)acrylates (PMMA) or polycarbonates (PC), with rubbers C), for example polybutadiene rubbers or acrylate rubbers, with particulate or fibrous fillers or reinforcers D), especially glass fibers, and/or with additives E) customary in plastics, for example thermal or UV stabilizers, lubricants, flame retardants, antistats, dyes or color pigments, etc., to give thermoplastic molding materials.

Preferred thermoplastic molding materials comprise

1 to 95% by weight of copolymers A),

5 to 99% by weight of one or more thermoplastic polymers B) other than component A),

0 to 50% by weight of one or more rubbers C),

0 to 70% by weight of one or more particulate or fibrous fillers or reinforcers D) and

0 to 25% by weight of one or more additives E) customary in plastics,

where the percentages by weight are each based on the total weight of components A), B), C), D) and E), and together add up to 100% by weight.

Components B), C), D) and E) as such, and processes for preparing the thermoplastic molding materials from the individual components, are known to the person skilled in the art and are described in the prior art.

The inventive copolymers A) and the thermoplastic molding materials comprising the copolymers A) can be used by processes which are known to those skilled in the art and are described in the prior art, for example by injection molding, pressing, calendering or by extrusion, to produce moldings, films, fibers and foams.

The inventive moldings, films, fibers and foams are suitable for all fields of application known to those skilled in the art. More particularly, they are suitable for use as household articles, electronic components, medical technology components and motor vehicle components.

The inventive copolymers A) have a comparatively good intrinsic color and a reduced soil particle content compared to known copolymers of this kind, even after prolonged operating time of the polymerization.

The invention is illustrated in detail by examples hereinafter.

### EXAMPLES

In the inventive examples and comparative examples which follow, copolymers were prepared in each case and the properties thereof were determined.

Feedstocks:

The component A1-i used was commercial styrene with a purity of >99.8% by weight.

The component A2-i used was commercial acrylonitrile.

The component A3-i used was commercial maleic anhydride with a purity of >99.8% by weight.

The solvent used for the polymerization was commercial ethylbenzene.

Preparation and Properties of the Copolymers

Into a continuous stirred tank (40 l flow tank) in the steady state, which was purged with nitrogen, amounts of each of components A1), A2), A3) and of the solvent were metered in per unit time such that copolymers were obtained which comprised the proportions by weight each specified in table 1 of structural units which derive from components A1), A2) and A3) (see below for determination method). The temperature of the polymerization mixture was in each case 145° C.; the polymerization was in each case initiated purely thermally. Calculated from the time of attainment of a steady state of the polymerization, after the operating times specified in table 1, unconverted monomers, solvents and other low molecular weight compounds were removed after identical two-stage processes in each case from the polymerization mixtures drawn off continuously from the stirred tank. The copolymers thus obtained were each pelletized and dried, and the properties thereof, which are reproduced in table 1, were analyzed.

The proportions by weight of the structural elements of the copolymers which derive from components A1), A2) and A3) and the properties of the copolymers were determined as follows:

Proportions by weight of the structural elements which derive from components A1), A2) and A3) in the copolymers [% by weight]:

The copolymer pellets produced as described were used to produce films of defined thickness by melt pressing. The proportions by weight of the structural elements which derive from components A1), A2) and A3) were determined by means of quantitative IR spectroscopy on these films. The percentages by weight are each based on the total weight of the copolymers and together add up to 100% by weight.

Viscosity number VN [ml/g]:

The viscosity number VN was determined at 25° C. using a 0.5% by weight solution of the particular copolymer in dimethylformamide to DIN 53726.

Yellowness index YI [dimensionless]:

The yellowness index YI was determined to ASTM D 1925 on injection-molded slabs (dimensions: 60 mm×60 mm×2 mm; injection molding melt temperature 240° C.; injection mold temperature 60° C.).

Soil particle content [mm² of soil particles/m²]:

By means of a PS 25C pellet scanner from OCS, the size and number of the inclusions other than the copolymer matrix were detected in 2160 g of pellets in each case, and the soil particle content was determined therefrom.

The proportions by weight of the structural elements which derive from components A1), A2) and A3) in the copolymers, the resulting mathematical product of the percentages by weight of the structural units which derive from component A2) and the percentages by weight of the structural units which derive from component A3), and the properties of the copolymers as a function of the operating time can be found in table 1.

TABLE 1
Composition, operating times of the polymerization
and properties of the copolymers

| | Example* | | | | | | |
|---|---|---|---|---|---|---|---|
| | 1 | 2 | 3 | C-4 | C-5 | 6 | 7 |
| Proportions by weight of the | | | | | | | |
| structural elements which | | | | | | | |
| derive from components A1), | | | | | | | |
| A2) and A3) in the copolymers** | | | | | | | |
| A1-i [% by wt.] | 72.5 | 68.4 | 68.4 | 68.0 | 67.2 | 81.2 | 80.4 |
| A2-i [% by wt.] | 25.8 | 29.8 | 29.7 | 29.8 | 29.8 | 15.2 | 16.0 |
| A3-i [% by wt.] | 1.7 | 1.8 | 1.9 | 2.2 | 3.0 | 3.6 | 3.6 |
| Mathematical product of | 43.9 | 53.6 | 56.4 | 65.6 | 89.4 | 54.7 | 57.6 |
| percentages by weight of | | | | | | | |
| components A2) and A3) [%² | | | | | | | |
| by wt.]** | | | | | | | |
| Properties | | | | | | | |
| Viscosity number VN [ml/g]** | 66 | 67 | 67 | 69 | 67 | 67 | 64 |
| Yellowness index YI | 9 | 13 | 15 | 16 | 21 | 10 | 8 |
| [dimensionless]** | | | | | | | |
| Soil particle content | | | | | | | |
| [mm² of soil particles/m²] | | | | | | | |
| after operating time 24 h | 2 | 5 | 5 | 21 | 43 | 4 | 6 |
| after operating time 72 h | 3 | 10 | 11 | >100 | >100 | 6 | 9 |
| after operating time 144 h | 5 | 12 | 12 | >100 | >100 | 7 | 10 |
| after operating time 288 h | 6 | 14 | 12 | >100 | >100 | 9 | 12 |

*examples designated “C” are comparative examples,
**these values are independent of the operating time owing to the steady-state conditions

The examples demonstrate that the inventive copolymers A) have a comparatively good intrinsic color and a reduced soil particle content compared to known copolymers of this kind even after prolonged operating time of the polymerization.

1-9. (canceled)

10. A process for preparing copolymers A) with a reduced soil particle content, comprising
49.2 to 93.2% by weight of structural units which derive from one or more vinylaromatic monomers (component A1)),
6 to 50% by weight of structural units which derive from one or more vinyl cyanides (component A2)),
0.8 to 7% by weight of structural units which derive from one or more dicarboxylic anhydrides (component A3)) and
0 to 25% by weight of structural units which derive from further copolymerizable monomers (component A4)),
where the percentages by weight are each based on the total weight of the structural units which derive from components A1), A2), A3) and A4), and together do not exceed 100% by weight,
by bulk or solution polymerization,
wherein the mathematical product of the percentages by weight of the structural units which derive from component A2) and the percentages by weight of the structural units which derive from component A3) in the copolymer A) is in the range from 40%² by weight to 65%² by weight.

11. The process according to claim 10, wherein the polymerization is initiated thermally and without addition of a polymerization initiator.

12. The process according to claim 10, wherein the polymerization is performed as a solution polymerization in the presence of an organic solvent.

13. The process according to claim 10, wherein
component A1) is styrene, α-methylstyrene, p-methylstyrene, t-butylstyrene, vinylnaphthalene or a mixture of two or more of these monomers,
component A2) is acrylonitrile, methacrylonitrile or a mixture of these monomers and component A3) is maleic anhydride, methylmaleic anhydride, itaconic anhydride or a mixture of two or more of these monomers.

14. The process according to claim 10, wherein the copolymer A) is a styrene-acrylonitrile-maleic anhydride copolymer.

15. A copolymer A) with reduced soil particle content, preparable by the process according to claim 10.

16. A thermoplastic molding material comprising
1 to 95% by weight of the copolymer A) according to claim 15,
5 to 99% by weight of one or more thermoplastic polymers B) other than component A),
0 to 50% by weight of one or more rubbers C),
0 to 70% by weight of one or more particulate or fibrous fillers or reinforcers D)
and 0 to 25% by weight of one or more additives E) customary in plastics,
where the percentages by weight are each based on the total weight of components A), B), C), D) and E), and together do not exceed 100% by weight.

17. A method of use of a copolymer A) according to claim 15 or of a thermoplastic molding material according to claim 16 for producing moldings, films, fibers and foams.

18. A molding, film, fiber or foam obtainable from the copolymer A) according to claim 15.

19. A molding, film, fiber or foam obtainable from a thermoplastic molding material according to claim 16.
